(19) United States
(12) Patent Application Publication
(10) Pub. No.: US 2007/0007023 A1
(43) Pub. Date: Jan. 11, 2007

(54) Rotatable pneumatic power tool and method for quickly stopping rotation of the same

(76) Inventors: Paul A. Becker, Evans City, PA (US); Carl L. Schodde JR., Pittsburgh, PA (US); Herbert L. Poore JR., Freedom, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/175,974

(22) Filed: Jul. 6, 2005

(51) Int. Cl. B25B 21/02

(52) U.S. Cl. 173/1; 173/169

(57) ABSTRACT

A pneumatic power tool in which a throttle valve controls the rate at which the pressurized air within the tool may be released. By doing so, the rotatable motor may not only be quickly accelerated through the use of the pressurized air but, furthermore, may be quickly decelerated by using the same pressurized air. The subject invention is also directed to a method for controlling the speed of a rotating pneumatic power tool by blocking the flow of the exhaust air.

### BACKGROUND OF THE INVENTION

1. Field of the Invention

This invention relates to a rotatable pneumatic power tool and, more particularly, to a rotatable pneumatic power tool having a design, whereby the exhaust air may be blocked to quickly stop rotation of the tool.

2. Description of Related Art

Rotating pneumatic tools may be operated in environments where it is very important, when the operator desires, to stop rotation of the tool as soon as possible. In one particular example, pneumatic grinders are operated in radioactive or chemically toxic areas and the operator is wearing a containment suit. After the operator releases the trigger on the grinder and assumes the grinding wheel has stopped, the operator is now vulnerable because frequently the grinding wheel is still rotating. If a pneumatic grinder does not stop quickly, then there is the possibility that the operator's containment suit may be cut due to the relatively slow deceleration of the pneumatic grinding wheel. In particular, as a trigger of the pneumatic tool is released, the pneumatic grinding wheel gradually slows from speeds in excess of 6,000 RPM's. During this period of deceleration, the operator may drop, slip or rest the tool against his body, causing the wheel to tear the containment suit, thereby exposing the operator's body to the hazardous atmosphere.

One way to halt the grinding wheel quicker is to depress the throttle and then leave the rotating grinding wheels against the workpiece. This technique could cause the tool to grab the work, thereby taking the tool out of the operator's hand. Furthermore, using the workpiece to slow the grinding wheel could also cause the grinding wheel to explode causing fragments to injure the operator and other workers in the vicinity.

U.S. Pat. No. 6,135,213 is directed to a pneumatic power wrench with an adjustable exhaust restriction. Through the use of an outlet flow deflecting unit 20 on the wrench, relatively low inlet pressures during initial operation of the tool produce a force on activating surface 45 which displaces the valve head 43 a small distance relative to the seat 26, thereby permitting only limited outlet flow. At the final tightening stage of the power wrench, high pressure in the actuator chamber 46, in combination with the low pressure drop across the valve head 43, results in the valve element 28 occupying its full open position such that the outlet flow is unrestricted. Therefore, while this tool is controlled by the outlet flow of air, it does not provide a means of quickly stopping the pneumatic power wrench.

U.S. Pat. No. 5,901,794 is directed to a pneumatic power wrench equipped with an outlet flow restricting means 24 in the form of a valve spindle 29, an annular valve seat 34 and a valve element 32. As stated in column 3, lines 39-45, the valve element 32 is displaceable between a maximum flow and a minimum flow. However, once again, this design is not directed to controlling the outlet flow to quickly stop the tool.

U.S. Pat. No. 4,346,765 is directed to a speed responsive motor shutoff mechanism for a fluid operated tool. Based upon centrifugal force exerted by a rotating flywheel, the shutoff mechanism permits a closure member to shut off motor exhaust fluid flow to stop the motor. The purpose of this design is to interrupt the motor exhaust flow at a predetermined minimum speed of the tool motor as the motor approaches the stall condition. However, once again this design does not provide a quick stop for the motor.

A design is needed whereby a rotatable pneumatic power tool may be stopped very quickly to minimize the possibility of damage when the tool is no longer in use after air supply to the tool has been disrupted.

### SUMMARY OF THE INVENTION

One embodiment of the invention is directed to a pneumatic power tool having a housing and a pneumatic rotation motor within the housing drivingly connected to an output shaft. There is an air inlet passageway in the housing for pressurized air used to drive the motor and an air outlet passageway in the housing for exhaust air from the motor. A throttle valve operable from outside of the housing is located within the outlet passageway, wherein the throttle valve is adjustable between an open position and a fully closed position, such that if the tool is operating with the throttle valve open, air is flowing through the motor and driving the motor, and when the throttle valve is closed, the exhaust air is blocked and the motor quickly stops.

Another embodiment of the invention is directed to a method for controlling the speed of a rotating pneumatic power tool having a housing with a pneumatic rotation motor drivingly connected to an output shaft. The method comprises the steps of providing air under pressure at an air inlet passageway to drive the motor, providing an air outlet passageway in the housing to permit air to exhaust from the motor, and controlling a throttle valve from outside of the housing to completely block the outlet passageway to prevent air flow through the outlet passageway and to quickly stop rotation of the motor.

### BRIEF DESCRIPTION OF THE SEVERAL VIEWS OF THE DRAWINGS

FIG. 1 is an end view of the tool in accordance with the subject invention;

FIG. 2 is a cross-section along lines II-II of FIG. 1 with the throttle valve in the closed position;

FIG. 3 illustrates a portion of the cross-section in FIG. 2 with the throttle valve in the open position; and

FIG. 4 is a side view of the post used for the throttle valve.

### DETAILED DESCRIPTION OF THE INVENTION

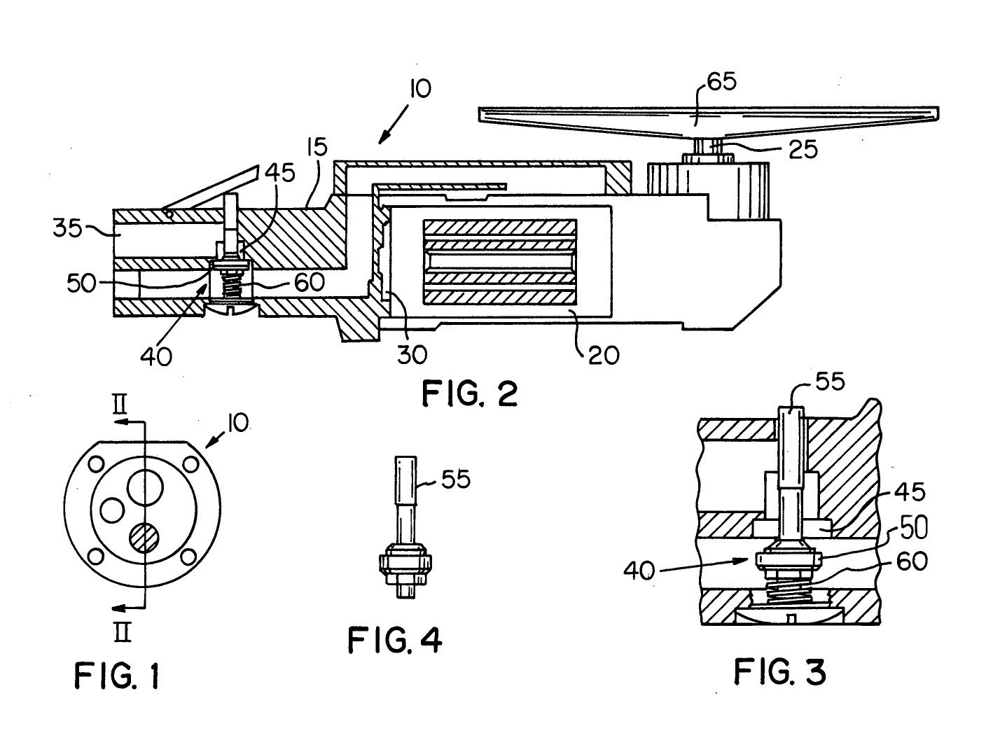

FIG. 1 illustrates an end view of the tool 10, while FIG. 2 illustrates a cross-sectional view along lines 2-2 of FIG. 1 of the tool 10.

The tool 10 is comprised of a housing 15 with a pneumatic rotation motor 20 mounted within the housing 15. The motor 20 is drivingly connected to an output shaft 25. Typically, this connection between the motor 20 and the output shaft 25 would be through mating bevel gears (not shown). Pressurized air used to drive the motor 20 enters the housing 15 through an air inlet passageway 30. The pressurized air once it passes through the motor 20 becomes exhaust air from the motor 20 and leaves the housing 15 through an air outlet passageway 35. A throttle valve 40 is located within the outlet passageway 35 and is adjustable between a fully closed position, as illustrated in FIG. 2, and an open position as illustrated in FIG. 3. With the throttle valve 40 open, the tool operates with air flowing through the motor 20 and, when the throttle valve 40 is closed, the exhaust air is blocked and the rotation of the motor 20 quickly stops because, not only is the air supply discontinued but, furthermore, the pressurized air surrounding the motor 20 provides a significant drag upon the rotation of the motor 20, thereby promoting significant deceleration to stop the rotation.

The throttle valve 40 includes a throttle valve port 45 within the outlet passageway 35. The throttle valve 40 includes a disc 50 which, in the valve closed position, covers and seals the port 45 (FIG. 2). Directing attention to FIGS. 3 and 4, the throttle valve 40 further includes a post 55 slidably mounted within and protruding from the housing 15. The post 55 is connected to the disc 50 such that when the post 55 is depressed within the housing 15, the disc 50 is moved away from the port 45 and air is permitted to flow through the outlet passageway 35. The post 55 is biased to seal the port 45 with the disc 50. One such mechanism for biasing the post 55 is a coil spring 60.

The pneumatic power tool 10 illustrated in the figures is one that is manually operable by depressing the post 55. However, it should be appreciated that the mechanism discussed herein for quickly stopping the rotation of a rotatable pneumatic power tool may apply as well to automatic or semi-automatic tools.

Furthermore, while the pneumatic power tool 10 discussed herein is a grinder which, directing attention to FIG. 2, drives an output shaft 25 which is connected to a grinding wheel 65, the subject invention may be applied to any other pneumatic rotary power tools including, but not limited to, a drill or a sander.

The subject invention is also directed to a method for controlling the speed of a rotating pneumatic power tool 10 having a housing 15 with a pneumatic rotation motor 20 drivingly connected to an output shaft 25. The method comprises the steps of providing air under pressure at an air inlet passageway 30 to drive the motor 20 and then providing an air outlet passageway 35 in the housing 15 to permit air to exhaust from the motor 20. By controlling a throttle valve 40, the outlet passageway 35 may be completely blocked to prevent air flow through the outlet passageway 35 to quickly stop the rotation of the motor 20. Controlling the throttle valve 40 may be achieved by adjusting the position of the valve 40 from its open position to a fully closed position such that the exhaust air is blocked. Just as discussed before, operation of the throttle valve 40 may be manual, automatic or semi-automatic.

In one particular example of operation, compressed air enters the housing 15 of the tool 10 through a one-quarter inch NPT fitted at a rated 90 psig maximum. Compressed air flows through the housing 15 and reaches a one-half horsepower air motor which is governed to 6,000 rpm. The air powers the motor 20 and, instead of immediately being exhausted to the atmosphere, it is cycled back through the housing 15. The throttle valve port 45 is connected to the disc 50 blocking the exhaust. When the post 55 is depressed, it opens the air outlet passageway 35 allowing the air to flow through the tool 10 and speeding the grinder wheel to 6,000 rpm. A one-half inch NPT thread (not shown) at the air outlet passageway 35 allows for an exhaust tube to be attached thereto for directing the4 exhaust away from the work area. When the throttle valve post 45 is released, the air outlet passageway is blocked, trapping the incoming compressed air in the completely sealed housing causing the rotatable pneumatic tool 10 to stop almost instantaneously.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

We claim:

1. A pneumatic power tool comprising:
a) a housing,
b) a pneumatic rotation motor within the housing drivingly connected to an output shaft,
c) an air inlet passageway in the housing for pressurized air used to drive the motor,
d) an air outlet passageway in the housing for exhaust air from the motor, and
e) a throttle valve operable from outside of the housing located within the outlet passageway, wherein the throttle valve is adjustable between an open position and a fully closed position, such that if the tool is operating with the valve open, air is flowing through and driving the motor, and when the throttle valve is closed, the exhaust air is blocked and the motor quickly stops.

2. The tool according to claim 1, wherein the throttle valve includes a throttle valve port within the outlet passageway and wherein the throttle valve further includes a disc which in the valve closed position covers and seals the port.

3. The tool according to claim 2, wherein the throttle valve further includes a post slidably mounted within and protruding from the housing and wherein the post is connected to the disc such that when the post is depressed, the disc is moved away from the port and air is permitted to flow through the outlet passageway.

4. The tool according to claim 3, wherein the disc is biased to seal the port.

5. The tool according to claim 1, wherein the throttle valve is manually operable.

6. The tool according to claim 1, wherein the tool is a grinder.

7. A method for controlling the speed of a rotating pneumatic power tool having a housing with a pneumatic rotation motor drivingly connected to an output shaft comprising the steps of:
a) providing air under pressure at an air inlet passageway to drive the motor,
b) providing an air outlet passageway in the housing to permit air to exhaust from the motor,
c) controlling a throttle valve to completely block the outlet passageway to prevent air flow through the outlet passageway and to quickly stop rotation of the motor.

8. The method according to claim 7, wherein the step of controlling the throttle valve comprises adjusting the position of the valve from an open position to a fully closed position such that the exhaust air is blocked.

9. The method according to claim 7, wherein the throttle valve is manually operable.

10. The method according to claim 7, wherein the throttle valve is biased in the closed position.

11. The method according to claim 7, wherein the tool is a grinder.
